(19) United States
(12) Patent Application Publication
(10) Pub. No.: US 2010/0116953 A1
(43) Pub. Date: May 13, 2010

(54) QUICK DISCONNECT BRACKET ASSEMBLY

(75) Inventors: Sammy Abusada, Iowa City, IA (US); Christopher Baker, Muscatine, IA (US); Richard W. Paulsen, Muscatine, IA (US); Robert Cleo Stroda, Illinois City, IL (US); Kate Laurel Kamm, Muscatine, IA (US)

Correspondence Address: FAEGRE & BENSON LLP;PATENT DOCKETING - INTELLECTUAL PROPERTY (77012), 2200 WELLS FARGO CENTER, 90 SOUTH SEVENTH STREET, MINNEAPOLIS, MN, 55402-3901, US

(73) Assignee: HNI Technologies Inc., Muscatine, IA (US)

(21) Appl. No.: 12/481,343

(22) Filed: Jun. 9, 2009

Related U.S. Application Data
(60) Provisional application No. 61/059,980, filed on Jun. 9, 2008.

(51) Int. Cl. F16M 13/00

(52) U.S. Cl. 248/201

(57) ABSTRACT

A cantilever bracket assembly includes a case bracket having an elongated channel, a generally L-shaped mounting bracket and means for locking the case bracket to the mounting bracket. The L-shaped mounting bracket includes a first portion having a protrusion for attaching the mounting bracket to a vertical standard and a second portion slidable within the elongated channel of the case bracket. The case bracket is slidable between an unlocked position and a locked position relative to the mounting bracket.

### CROSS-REFERENCE TO RELATED APPLICATION

This application claims priority under 35 U.S.C. §119 to U.S. Provisional Application No. 61/059,980, filed on Jun. 9, 2008, entitled “Quick Disconnect Bracket Assembly,” which is incorporated herein by reference in its entirety for all purposes.

### TECHNICAL FIELD

The present invention relates generally to the field of modular storage assemblies. In particular, the present invention relates to a cantilever bracket assembly that can be quickly assembled and disassembled.

### BACKGROUND

A clean and well-organized workspace can facilitate a productive work environment and lead to increased efficiency. Storage units that can be adapted to accommodate various types of work allow versatility to a single workspace by maximizing the workspace and creating flexible work environments. Modular storage units are often used in cubicle settings to provide a team environment in which numerous people can be generally located in one area while also providing individual workspaces for each person. By using modular storage units, each workspace can also be adapted to meet the individual needs of each person. For example, various different desks, shelving units, and towers can be connected to the frame of the cubicle to create a personalized workspace.

Because the business world is dynamic, workspaces are constantly changing. Assembling and disassembling the workspaces can be time-consuming and reduce productivity as the work environment is built or modified, resulting in wasted time and money. In addition, some frameworks and storage units may require special tools or expertise to assemble or disassemble. There is therefore a need in the art for an assembly which allows quick installation or modification of existing structures.

### SUMMARY

In one embodiment, the present invention is a bracket assembly. The cantilever bracket assembly includes a case bracket having an elongated channel, a generally L-shaped mounting bracket and means for locking the case bracket to the mounting bracket. The L-shaped mounting bracket includes a first portion having a protrusion for attaching the mounting bracket to a vertical standard and a second portion slidable within the elongated channel of the case bracket. The case bracket is slidable between an unlocked position and a locked position relative to the mounting bracket.

In another embodiment, the present invention is a locking bracket assembly. The locking bracket assembly includes a case bracket, a cantilever bracket and a locking mechanism. The case bracket includes an elongated panel having a top extension extending substantially perpendicular to the elongated panel, a bottom extension extending substantially perpendicular to the elongated panel and a cut-out. The cantilever bracket is slidable within the case bracket and includes a mount flange having a protrusion for engaging an aperture of a vertical support and an elongated channel having a cut-out. The locking mechanism is positionable in a first position and a second position and locks the case bracket to the cantilever bracket.

In yet another embodiment, the present invention is a method of locking a storage unit onto a vertical support. The method includes attaching a mounting bracket to the vertical support and attaching a case bracket onto the storage unit. Each of the mounting bracket and the case bracket includes a channel having a cut-out. The method further includes sliding the channel of the case bracket over the channel of the mounting bracket, aligning the cut-out in the channel of the case bracket with the cut-out in the channel of the mounting bracket, and engaging a locking mechanism through the cut-outs of the case bracket and the mounting bracket.

Various other aspects are contemplated and should be understood with reference to the text and drawings that follow.

### BRIEF DESCRIPTION OF THE DRAWINGS

FIG. 1 is a schematic view of a modular storage unit using a bracket assembly, according to one embodiment of the present invention.

FIG. 2A is a front schematic view of a mounting bracket of the bracket assembly, according to one embodiment of the present invention.

FIG. 2B is a bottom schematic view of the mounting bracket, according to one embodiment of the present invention.

FIG. 3 is a schematic view of a case bracket of the bracket assembly, according to one embodiment of the present invention.

FIG. 4A is a schematic view of a ball latch of the bracket assembly, according to one embodiment of the present invention.

FIG. 4B is a schematic view of the ball latch positioned within the mounting bracket, according to one embodiment of the present invention.

FIG. 5A is a front perspective view of the mounting bracket positioned within the case bracket, according to one embodiment of the present invention.

FIG. 5B is a rear perspective view of the mounting bracket positioned within the case bracket, according to one embodiment of the present invention.

FIG. 6 is a schematic view of an alternative embodiment of the mounting bracket of the bracket assembly, according to one embodiment of the present invention.

FIG. 7 is a schematic view of an alternative embodiment of the case bracket of the bracket assembly, according to one embodiment of the present invention.

FIG. 8A is a schematic view of a spring clip of the bracket assembly, according to one embodiment of the present invention.

FIG. 8B is a rear perspective view of the spring clip positioned within the mounting bracket, according to one embodiment of the present invention.

FIG. 9 is a schematic view of an alternative embodiment of the mounting bracket of the bracket assembly, according to one embodiment of the present invention.

FIG. 10 is a schematic view of an alternative embodiment of the case bracket of the bracket assembly, according to one embodiment of the present invention.

FIG. 11 is a schematic view of a spring clip of the bracket assembly, according to one embodiment of the present invention.

FIG. 12A is a perspective view of the spring clip positioned within the mounting bracket in a relaxed state, according to one embodiment of the present invention.

FIG. 12B is a perspective view of the spring clip positioned within the mounting bracket in a compressed state, according to one embodiment of the present invention.

While the invention is amenable to various modifications and alternative forms, some embodiments have been shown by way of example in the drawings and are described in detail below. As alluded to above, the intention, however, is not to limit the invention by those examples. On the contrary, the invention is intended to cover all modifications, equivalents, and alternatives.

### DETAILED DESCRIPTION

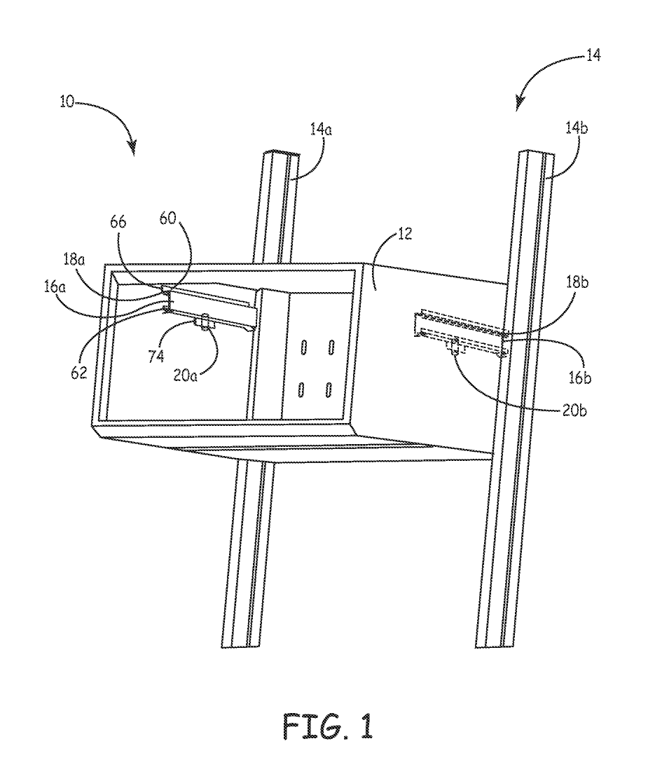

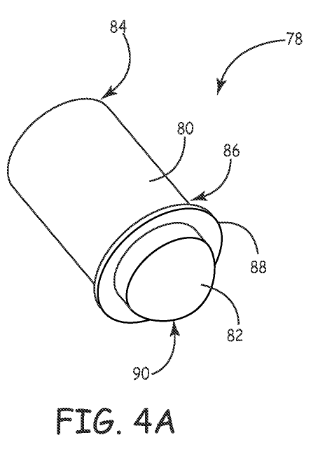

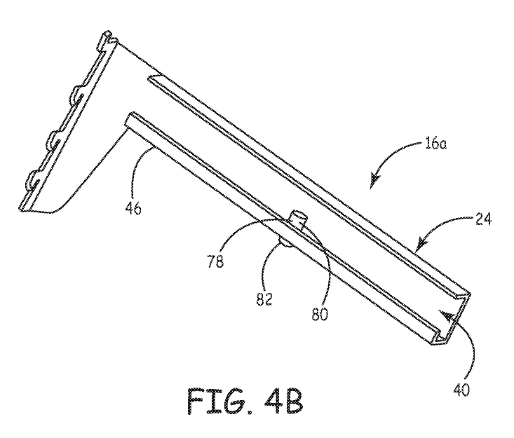

FIG. 1 shows a schematic view of a bracket assembly 10 for mounting a modular storage unit 12 onto a vertical support assembly 14 having a first vertical standard 14a and a second vertical standard 14b. The bracket assembly 10 maintains the storage unit 12 to the vertical support assembly 14 in a cantilevered manner and includes first and second mounting brackets 16a and 16b (collectively referred to as “mounting brackets 16”), first and second case brackets 18a and 18b (collectively referred to as “case brackets 18”) and first and second locking mechanisms 20a and 20b (FIG. 4A) (collectively referred to as “locking mechanisms 20”). The first and second mounting brackets 16a and 16b, second case bracket 18b and first and second locking mechanisms 20a and 20b are shown in phantom in FIG. 1. The bracket assembly 10 allows the storage unit 12 to be quickly assembled and disassembled onto the vertical support assembly 14 and can be used in any situation where it is desired to have an easily modifiable system. For example, the bracket assembly 10 may be used in an office environment where individual workspaces are created using a framework structure, such as cubicles. By using the bracket assembly 10 to mount the storage unit 12 onto the vertical support assembly 14, the amount of time and energy expended on creating the work space is reduced. Although FIG. 1 depicts the storage unit 12 as an enclosed shelving unit, any modular unit may be used, such as an open shelving unit, a cabinet or a tray.

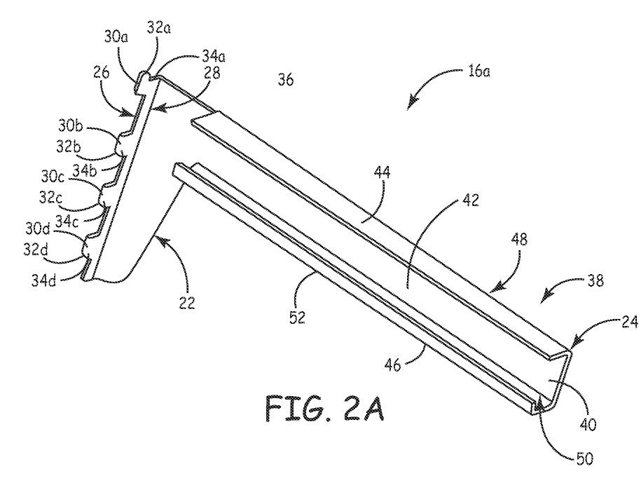

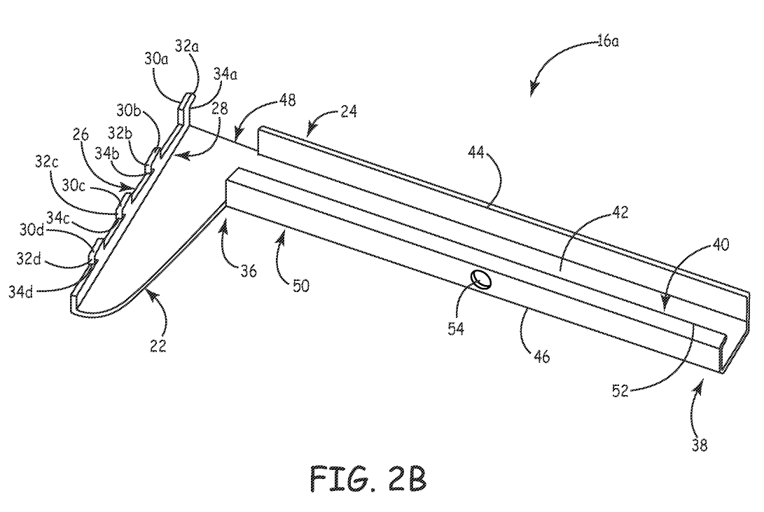

FIG. 2A shows a front schematic view of the first mounting bracket 16a and FIG. 2B shows a bottom schematic view of the first mounting bracket 16a. The mounting brackets 16 allow quick assembly and disassembly of the case brackets 18 (FIG. 1) to and from the vertical support assembly 14 (FIG. 1). The second mounting bracket 16b is a mirror-image of the first mounting bracket 16a and can thus be described cumulatively with reference to the first mounting bracket 16a. The first mounting bracket 16a includes a mount flange 22 and a casing 24. The mount flange 22 is substantially L-shaped and includes a first edge 26 and a second edge 28. The first edge 26 includes a first L-shaped protrusion 30a, a second L-shaped protrusion 30b, a third L-shaped protrusion 30c and a fourth L-shaped protrusion 30d (collectively referred to as “L-shaped protrusions 30”) for engaging the vertical support assembly 14. The first L-shaped protrusion 30a extends upward to form a hook portion 32a. Each of the second, third and fourth L-shaped protrusions 30b, 30c and 30d extends downward to form a hook portion 32b, 32c and 32d with a mouth 34b, 34c and 34d, respectively, formed between the hook portion 32b, 32c and 32d and the first edge 26 of the mount flange 22. The second edge 28 of the mount flange 22 connects the mount flange 22 to the casing 24.

The casing 24 has a trailing end 36 and a leading end 38 and is formed as a channel 40 including a guide flange 42, a top flange 44 and a bottom flange 46. The trailing end 36 of the casing 24 is connected to the second edge 28 of the mount flange 22. The top flange 44 extends substantially perpendicularly from a top edge 48 of the guide flange 42. The bottom flange 46 extends substantially perpendicularly from a bottom edge 50 of the guide flange 42 and includes a lip 52. The lip 52 extends substantially perpendicularly from the bottom flange 46 towards the top flange 44 such that the lip 52 is substantially parallel to the guide flange 42. The space formed between the guide flange 42, the top flange 44 and the bottom flange 46 defines the channel 40.

As can be seen in FIG. 2B, the bottom flange 46 also includes a cut-out 54 between the trailing and leading ends 36 and 38 of the casing 24. The cut-out 54 is sized to partially accept the locking mechanism 20 (FIG. 4A). In one embodiment, the cut-out 54 is substantially circular in shape.

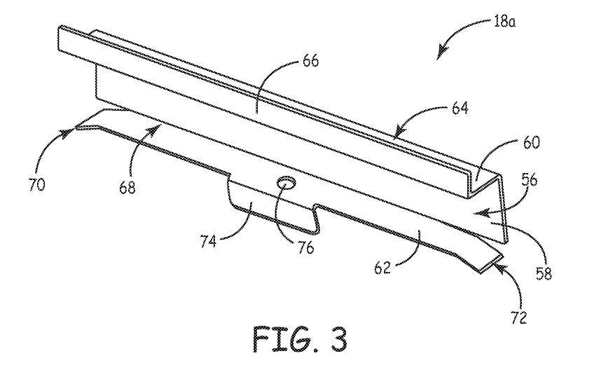

FIG. 3 shows a schematic view of the first case bracket 18a of the bracket assembly 10 (FIG. 1). The case brackets 18 allow the storage unit 12 (FIG. 1) to be easily mounted to the mounting brackets 16 for attachment to the vertical support assembly 14 (FIG. 1). The second case bracket 18b is a mirror-image of the first case bracket 18a and can thus be described cumulatively with reference to the first case bracket 18a. The first case bracket 18a is formed as a channel 56 having a guide flange 58, a top flange 60 and a bottom flange 62. The top flange 60 is generally L-shaped and extends substantially perpendicularly from a top edge 64 of the guide flange 58. The top flange 60 includes a lip 66 extending substantially perpendicularly from the top flange 60 and away from the bottom flange 62.

The bottom flange 62 extends substantially perpendicularly from a bottom edge 68 of the guide flange 58 and has a first end 70 and a second end 72. The bottom flange 62 includes a lip 74 extending substantially perpendicularly from the bottom flange 62 and away from the top flange 60. The first and second ends 70 and 72 of the bottom flange 62 are sloped away from the guide flange 58 to facilitate insertion of the first mounting bracket 16a (FIG. 2B) within the first case bracket 18a. The bottom flange 62 also includes a cut-out 76 between the first and second ends 70, 72 of the bottom flange 62 proximate the lip 74. The cut-out 76 is sized substantially similarly to the cut-out 54 of the first mounting bracket 16a. In one embodiment, the cut-out 76 is substantially circular in shape.

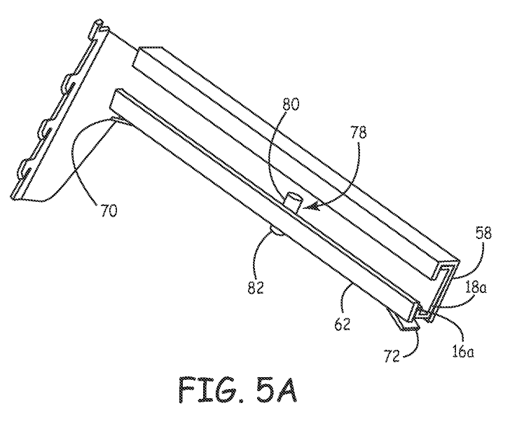

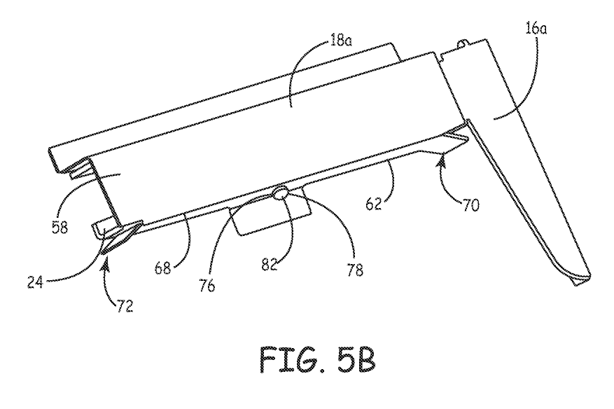

The space formed between the guide flange 58, the top flange 60 and the bottom flange 62 defines the channel 56. The guide flange 58, the top flange 60 and the bottom flange 62 of the first case bracket 18a have slightly greater heights than the guiding flange 42, top flange 44 and bottom flange 46, respectively, of the first mounting bracket 16a. The channel 56 of the first case bracket 18a is thus slightly taller and wider than the channel 40 of the first case bracket 18a so that the channel 40 forming the casing 24 of the first mounting bracket 16a is slidable within the channel 56 of the first case bracket 18a, as shown in FIG. 5A. The first mounting bracket 16a is positionable within the first case bracket 18a such that the cut-out 54 of the first mounting bracket 16a can be aligned with the cut-out 76 of the first case bracket 18a.

FIG. 4A shows a schematic view of a ball latch 78 of the bracket assembly 10 (FIG. 1), which functions as a locking mechanism 20a, 20b. The ball latch 78 is movable between a relaxed state and a compressed state and includes a sleeve 80 and a ball 82 positionable within the sleeve 80. The sleeve 80 has a first end 84 and a second end 86 with a flange 88 extending from the second end 86. The ball 82 has a rounded end 90 and is extendable from the second end 86 of the sleeve 80 when the ball latch 78 is in the relaxed state. When the ball latch 78 is in the relaxed state, there is no external force or pressure applied to the ball 82 and a spring (not shown) positioned within the sleeve 80 is in an expanded state, maintaining the ball 82 at least partially out of the sleeve 80. When the ball latch 78 is in the compressed state, an external force is applied at the rounded end 90 of the ball 82 such that the spring within the sleeve 80 is compressed to allow the ball 82 to be substantially fully positioned within the sleeve 80.

FIG. 4B shows a schematic view of the ball latch 78 positioned within the first mounting bracket 16a. To act as a locking mechanism, the ball latch 78 is positioned within the channel 40 of the casing 24 such that the ball 82 of the ball latch 78 extends through the cut-out 54 (FIG. 2B) in the bottom flange 46 of the casing 24. The flange 88 at the second end 86 of the sleeve 80 prevents the ball latch 78 from passing entirely through the cut-out 54 of the first mounting bracket 16a. The ball latch 78 functions to either allow the first case bracket 18a (FIG. 3) to be slidable over the first mounting bracket 16a or to be secured to the first mounting bracket 16a.

FIGS. 5A and 5B show a front schematic view and a rear schematic view, respectively, of the first mounting bracket 16a positioned within the first case bracket 18a. Because the first and second ends 70, 72 of the bottom flange 62 are sloped away from the bottom edge 68 of the guide flange 58, the ball 82 of the ball latch 78 (FIG. 4A) is slowly compressed as the first case bracket 18a slides around the first mounting bracket 16a. With the ball 82 compressed within the sleeve 80, the first case bracket 18a can slide over the first mounting bracket 16a without any interference from the ball latch 78. When the cut-out 76 of the first case bracket 18a aligns with the cut-out 54 (FIG. 2B) of the first mounting bracket 16a and the ball latch 78, the ball 82 is no longer compressed by the first case bracket 18a and deploys through the cut-out 76 of the first case bracket 18a. In this position, the ball 82 prevents the first case bracket 18a from moving relative to the first mounting bracket 16a.

To disconnect the first case bracket 18a from the first mounting bracket 16a, the ball 82 of the ball latch 78 is compressed into the sleeve 80 of the ball latch 78 so that the first case bracket 18a can move relative to the first mounting bracket 16a. When the ball 82 of the ball latch 78 no longer extends through the cut-out 76 of the first case bracket 18a, the first case bracket 18a is free to slide over the first mounting bracket 16a and to be removed from around the first mounting bracket 16a. The ball latch 78 thus allows the first case bracket 18a to be in either a first, unlocked position or a second, locked position relative to the first mounting bracket 16a.

Referring to all of the previous figures, a method of mounting the storage unit 12 onto the vertical support assembly 14 using the bracket assembly 10 is described. To mount the storage unit 12 onto the vertical support assembly 14, the first mounting bracket 16a is first mounted onto the first vertical standard 14a. The first vertical standard 14a includes a plurality of apertures (not shown) running the length of the vertical standard 14a. The apertures are sized to accept the L-shaped protrusions 30 of the first mounting bracket 16a. The hook portions 32b, 32c and 32d of the second, third and fourth protrusions 30b, 30c and 30d, respectively, function to lock the first mounting bracket 16a to the vertical support assembly 14a. To prevent the first mounting bracket 16a from being inadvertently displaced in the upward direction, the hook portion 32a of the first L-shaped protrusion 30a extends upward to provide an anti-disengagement feature.

Each of the apertures of the first vertical standard 14a is defined by a top edge of material and a bottom edge of material. The method of assembling includes inserting the hook portions 32 of the L-shaped protrusions 30 into the apertures. Following insertion of the hook portions 32 of the L-shaped protrusions 30 into the apertures, the first mounting bracket 16a is moved downward. As the first mounting bracket 16a is moved downward, the hook portions 32b, 32c and 32d of the second, third and fourth protrusions 30b, 30c and 30d, respectively, rest against the bottom edges of material of the first vertical standard 14a such that the bottom edges of material are received in the mouths 34b, 34c and 34d of the hook portions 32b, 32c and 32d, respectively. The mouths 34b, 34c and 34d of the hook portions 32b, 32c and 32d, respectively, act to releasably retain the first mounting bracket 16a to the first vertical standard 14a. The hook portion 32a of the first L-shaped protrusion 30a prevents the first mounting bracket 16a from lifting and disengaging from the aperture of the first vertical standard 14a.

The second mounting bracket 16b (FIG. 1) is similarly inserted into apertures in the second vertical standard 14b (FIG. 1) and moved downward to releasably retain the second mounting bracket 16b to an attachment site defined by the second vertical standard 14b.

In one embodiment, after the mounting brackets 16 are mounted onto the vertical standards 14, the first and second vertical standards 14a and 14b are spaced apart from one another at a distance substantially equal to a width of the storage unit 12. Before mounting the storage unit 12 onto the mounting brackets 16, the case brackets 18 are attached to the storage unit 12. In one embodiment, the case brackets 18 are attached to opposing interior walls of the storage unit 12 at the lips 66 of the top flanges 60 and the lips 74 of the bottom flanges 62 of the case brackets 18. The case brackets 18 can be attached to the storage unit 12 by any suitable means known in the art. In one embodiment, the case brackets 18 are welded to the storage unit 12.

Once the case brackets 18 are attached to the storage unit 12, the storage unit 12 with the case brackets 18 is moved towards the mounting brackets 16 such that the channels 56 of the case brackets 18 are aligned with the channels 40 of the mounting brackets 16. The case brackets 18 are then slid over the casings 24 of the mounting brackets 16. Because the first and second ends 70, 72 of the bottom flanges 62 of the case brackets 18 are sloped, the ball latches 78 are compressed with the balls 82 positioned within the sleeves 80 as the case brackets 18 are pushed over the mounting brackets 16, allowing the case brackets 18 to slide over the mounting brackets 16.

As mentioned above, when the cut-outs 76 of the case brackets 18 reach the ball latches 78, the balls 82 deploy from the sleeves 80 and extend through the cut-outs 76 of the case brackets 18. When the balls 82 extend through the cut-outs 76 of the case brackets 18, the case brackets 18, and thus the storage unit 12, are locked to the mounting brackets 16.

By assembling the bracket assembly 10 as described above, the mounting brackets 16 provide a means for releasably securing the storage unit 12 to the vertical support assembly 14. From the preceding description, it should be understood that the weight of the storage unit 12 optionally assists with retaining the mounting brackets 16 in the downward, secure position.

When it is desired to remove the storage unit 12 from the vertical support assembly 14 and the mounting brackets 16, the balls 82 of the ball latches 78 are compressed back into the sleeves 80 until they no longer engage the cut-outs 76 of the case brackets 18. Because the ball latches 78 no longer engage the cut-outs 76, the case brackets 18 are free to slide relative to the mounting brackets 16 as described above. The case brackets 18 and the storage unit 12 can then be removed from the mounting brackets 16.

To remove the mounting brackets 16 from the vertical support assembly 14, the mounting brackets 16 are slid upward and moved outward and away from the vertical support assembly 14. The hook portions 32 of the L-shaped protrusions 30 are then removed from the apertures, removing the mounting brackets 16 from the vertical support assembly 14.

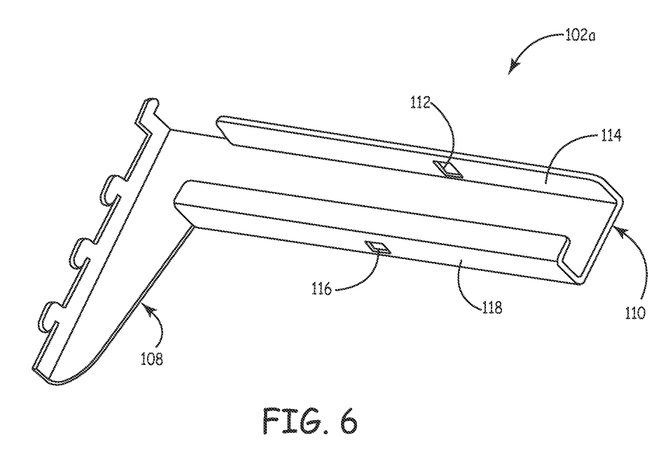

FIG. 6 shows a schematic view of a first mounting bracket 102a, which is a second embodiment of the first mounting bracket 16a. Similar to the first embodiment of the first mounting bracket 16a shown in FIG. 2A, the second embodiment of the first mounting bracket 102a includes a mount flange 108 connected substantially perpendicularly to a casing 110. The second embodiment of the mount flange 108 has substantially similar features and functions substantially similarly to the first embodiment of the mount flange 22.

The second embodiment of the casing 110 of the first mounting bracket 102a is also substantially similar to the first embodiment of the casing 24 of the first mounting bracket 16a except that the casing 110 includes a top cut-out 112 at a top flange 114 of the casing 110 and a bottom cut-out 116 at a bottom flange 118 of the casing 110, and the bottom flange 118 of the casing 110 does not include a lip. The cut-outs 112 and 116 at the top and bottom flanges 114 and 118, respectively, are aligned with one another. In one embodiment, the cut-outs 112 and 116 are substantially rectangular with the top cut-out 112 being slightly larger than the bottom cut-out 116. Other than the top and bottom cut-outs 112 and 116 of the casing 110, the second embodiment of the casing 110 includes the same features and functions substantially similarly to the first embodiment of the casing 24.

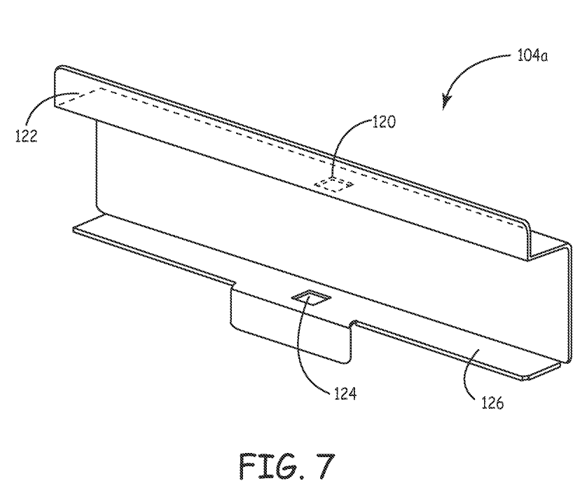

FIG. 7 shows a schematic view of a first case bracket 104a, which is a second embodiment of the first case bracket 18a. The second embodiment of the first case bracket 104a is substantially similar to the first embodiment of the first case bracket 18a except that the first case bracket 104a includes a top cut-out 120 (shown in phantom) at a top flange 122 of the first case bracket 104a and a bottom cut-out 124 at a bottom flange 126 of the first case bracket 104a. Similar to the cut-outs 112 and 116 of the first mounting bracket 16a, the cut-outs 120 and 124 are aligned with one another. In addition, the bottom flange 126 of the first case bracket 104a is substantially linear and is not sloped at its ends. In one embodiment, the cut-outs 120 and 124 are substantially rectangular and are sized substantially similarly to the cut-outs 112 and 116 of the first mounting bracket 102a, respectively. Otherwise, the second embodiment of the first case bracket 104a includes the same features and functions substantially similarly to the first embodiment of the first case bracket 18a.

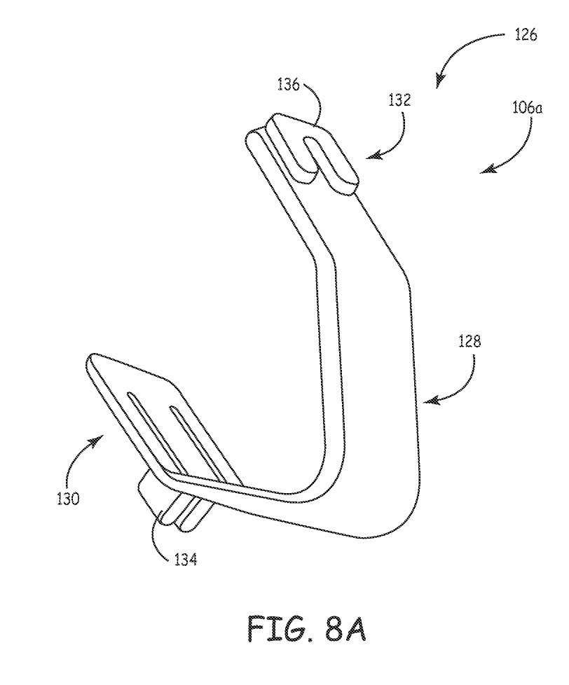

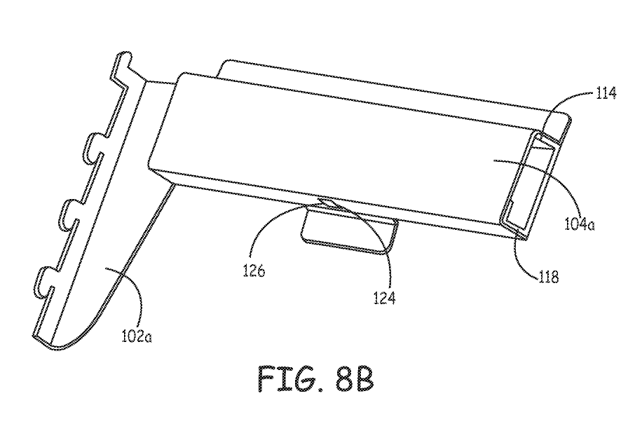

The second embodiments of the first mounting bracket 102a and the first case bracket 104a interact with each other in a substantially similar manner as the first embodiments of the first mounting bracket 16a and the first mounting bracket 18a. To mount the storage unit 12 onto the vertical support assembly 14 (FIG. 1) using the second embodiments of the first mounting bracket 102a and the first case bracket 104a, the first case bracket 104a is first slipped over the first mounting bracket 102a until the top cut-outs 112 and 120 of the first mounting bracket 102a and the first case bracket 104a, respectively, are aligned and the bottom cut-outs 116 and 124 of the first mounting bracket 102a and the first case bracket 104a, respectively, are aligned. The first case bracket 104a can then be locked in position relative to the first mounting bracket 102a using a spring clip 126 (FIG. 8A).

FIG. 8A shows a schematic view of a second embodiment of the locking mechanism 20a (FIG. 4A), including the spring clip 126. FIG. 8B shows a perspective view of the spring clip 126 positioned within the first mounting bracket 102a and the first case bracket 104a. The spring clip 126 maintains the first case bracket 104a to the first mounting bracket 102a and functions similarly to the ball latch 78 of the bracket assembly 10 (FIG. 1). The spring clip 126 includes a substantially V-shaped body portion 128 having a first end 130 and a second end 132. The first end 130 includes a first protrusion 134 sized to engage the top cut-outs 112 and 120 of the first mounting bracket 102a and the first case bracket 104a, respectively. Similarly, the second end 134 includes a second protrusion 136 sized to engage the bottom cut-outs 116 and 124 of the first mounting bracket 102a and the first case bracket 104a, respectively.

Referring also to FIGS. 6 and 7, the spring clip 126 is movable between a relaxed state and a compressed state. When the spring clip 126 is in the relaxed state (FIG. 8A), the first and second ends 130, 132 are substantially parallel to each other and are spaced from each other at a distance substantially equal to a distance between the top flange 114 and the bottom flange 118 of the first mounting bracket 102a. When the spring clip 126 is in the compressed state, the first and second ends 130 and 132 are pushed towards each other such that the spring clip 126 can be positioned between the top flange 114 and the bottom flange 118 of the first mounting bracket 102a.

To position the spring clip 126 within the first mounting bracket 102a and the first case bracket 104, the spring clip 126 is compressed and positioned between the top flange 114 and the bottom flange 118 of the first mounting bracket 102a. The first protrusion 134 is aligned with the top cut-outs 112 and 120 of the first mounting bracket 102a and the first case bracket 104a, respectively, and the second protrusion 136 is aligned with the bottom cut-outs 116 and 124 of the first mounting bracket 102a and the first case bracket 104a, respectively.

The spring clip 126 is then released to its relaxed state such that the first and second protrusions 134 and 136 of the spring clip 126 engage the top cut-outs 112 and 120 and bottom cut-outs 116, 124 of the first mounting bracket 102a and the first case bracket 104a, respectively. In this position, the first protrusion 134 the spring clip 126 extends through the top cut-outs 112 and 120 of the first mounting bracket 102a and the first case bracket 104a, respectively, and the second protrusion 136 extends through the bottom cut-outs 116 and 124 of the first mounting bracket 102a and the first case bracket 104a, respectively, to lock the first case bracket 104a in position relative to the first mounting bracket 102a.

To remove the first case bracket 104a from the first mounting bracket 102a, the first and second ends 130, 132 of the spring clips 126 are compressed towards each other to disengage the first protrusion 134 of the spring clip 126 from the top cut-outs 112 and 120 and to disengage the second protrusion 136 of the spring clip 126 from the bottom cut-outs 116 and 124. Once the spring clip 126 is disengaged from the first mounting bracket 102a and the first case bracket 104a, the spring clip 126 can be removed from within the first mounting bracket 102a. The first case bracket 104a is then free to slide off of the first mounting bracket 102a.

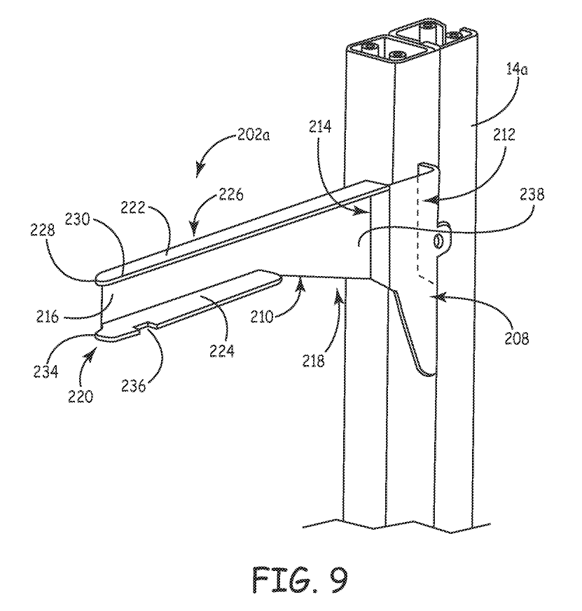

FIG. 9 shows a schematic view of a first mounting bracket 202a, which is a third embodiment of the first mounting bracket 16a, connected to the first vertical standard 14a. Similar to the first embodiment of the first mounting bracket 16a (FIG. 2A), the third embodiment of the mounting bracket 202a includes a mount flange 208 and a casing 210. The mount flange 208 includes a first edge 212 (shown in phantom) and a second edge 214 spaced from the first edge 212 such that the mount flange 208 is substantially C-shaped. The first and second edges 212 and 214 of the mount flange 208 are spaced a distance from each other to allow the mount flange 208 to wrap around part of the first vertical standard 14a. The mount flange 208 is connected to the casing 210 at the second edge 214 of the mount flange 208 at a substantially 90 degree angle.

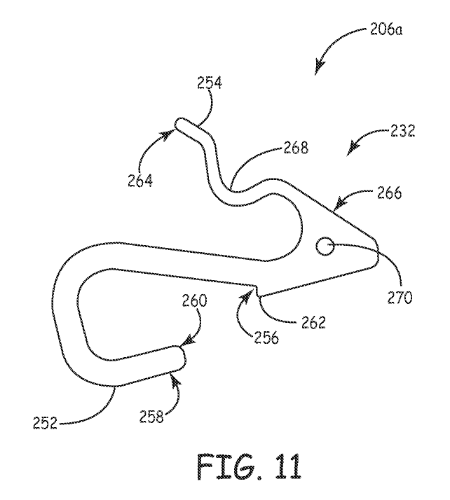

The casing 210 includes a guide flange 216 having a trailing end 218, a leading end 220, a top flange 222 and a bottom flange 224. The casing 210 is connected to the second edge 214 of the mount flange 208 at the trailing end 218 of the guide flange 216. The top flange 222 extends along a top edge 226 of the guide flange 216 from the trailing end 218 past the leading end 220 of the guide flange 216 and ends in a tip portion 228. The tip portion 228 of the top flange 222 is rounded and slightly bent downward to provide a lead-in into the casing 210. The top flange 222 includes a top cut-out 230 that extends from the tip portion 228 of the top flange 222 towards the trailing end 218 of the guide flange 216. The top cut-out 230 allows a spring clip 232 (FIG. 11) to act unimpeded by the thickness of the top material of the casing 210.

The bottom flange 224 begins between the trailing end 218 and the leading end 220 of the guide flange 216 and extends past the leading end 220 of the guide flange 216 and ends in a rounded tip portion 234. The bottom flange 224 is slightly wider than the top flange 222 and the tip portion 234 of the bottom flange 224 extends slightly farther past the leading end 220 of the guide flange 216 than the tip portion 228 of the top flange 222. The bottom flange 224 includes a bottom cut-out 236 located proximate the leading end 220 of the guide flange 216 and provides connection with the spring clip 232. At least a portion of the bottom cut-out 236 is aligned with the top cut-out 230. In one embodiment, the cut-outs 230 and 236 are substantially rectangular with the top cut-out 230 being longer than the bottom cut-out 236.

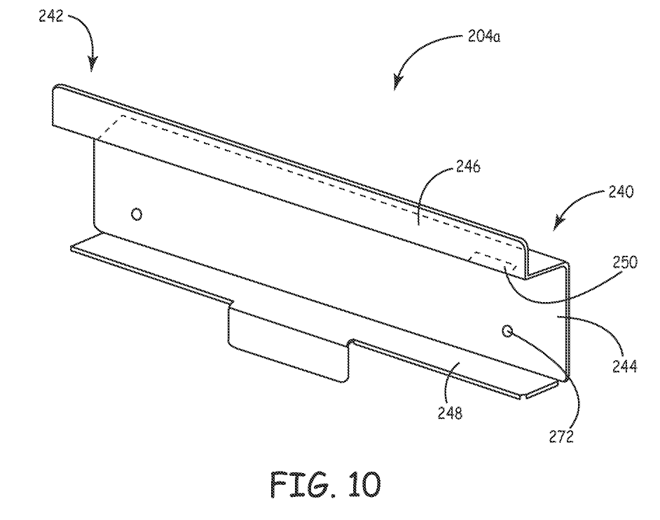

The guide flange 216 includes an engagement feature 238 proximate the trailing end 218 that extends from the guide flange 216 between the top and bottom flanges 222 and 224. The engagement feature 238 provides strength and resistance to the bracket assembly 100 to prevent the case bracket 204 (FIG. 10) from rotating forward. In one embodiment, the engagement feature 238 is stamped from the guide flange 216.

FIG. 10 shows a schematic view of a first case bracket 204a, which is a third embodiment of the first case bracket 18a. The third embodiment of the first case bracket 204a is substantially similar to the second embodiment of the first case bracket 104a (FIG. 7) and has a leading end 240, a trailing end 242, a guide flange 244, a top flange 246 and a bottom flange 248. The primary difference between the second embodiment of the first case bracket 104a and the third embodiment of the first case bracket 204a is that the first case bracket 204a only has one cut-out 250 (shown in phantom) through the top flange 246 of the first case bracket 204a. The cut-out 250 is located proximate the leading end 240 of the first case bracket 204a and is alignable with the top cut-out 230 of the casing 210 (FIG. 9). In one embodiment, the cut-out 250 is substantially rectangular.

The third embodiments of the first mounting bracket 202a and the first case bracket 204a interact with each other in a substantially similar manner as the first embodiments of the first mounting bracket 16a and the first mounting bracket 18a. To mount the storage unit 12 (FIG. 1) using the third embodiments of the first mounting bracket 202a and the first case bracket 204a, the first case bracket 204a is first slipped over the first mounting bracket 202a until the top cut-outs 230 and 250 of the first mounting bracket 202a and the first case bracket 204a are aligned. The first case bracket 204a can then be locked in position relative to the first mounting bracket 202a using a spring clip 232 (FIG. 11).

FIG. 11 shows a schematic view of a third embodiment of the locking mechanism 20a (FIG. 4A), including the spring clip 232. The spring clip 232 maintains the first case bracket 204a to the first mounting bracket 202a. The spring clip 232 includes a lever arm 252 and a spring arm 254. The lever arm 252 has a first end 256 and a hook portion 258 at a second end 260. The lever arm 252 is connected to the spring arm 254 at the first end 256, which includes a protrusion 262 sized to engage the bottom cut-out 236 of the first mounting bracket 202a.

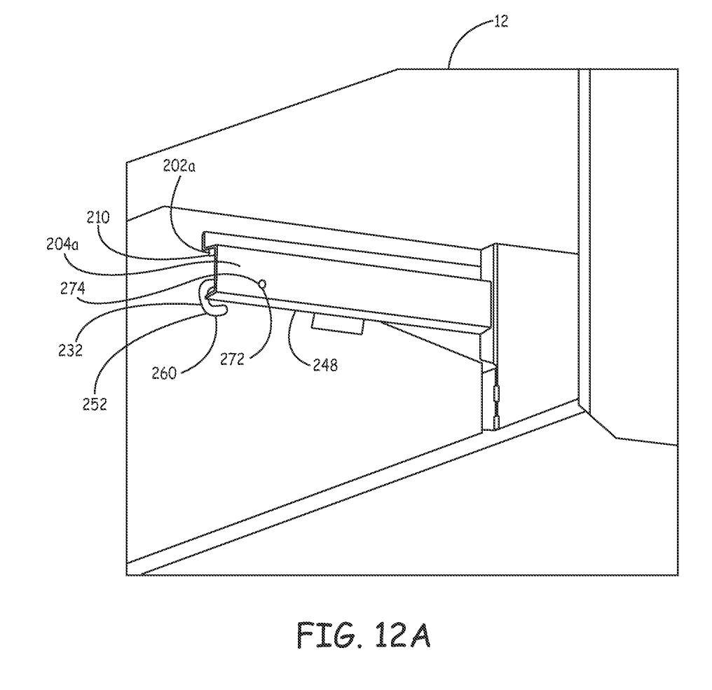

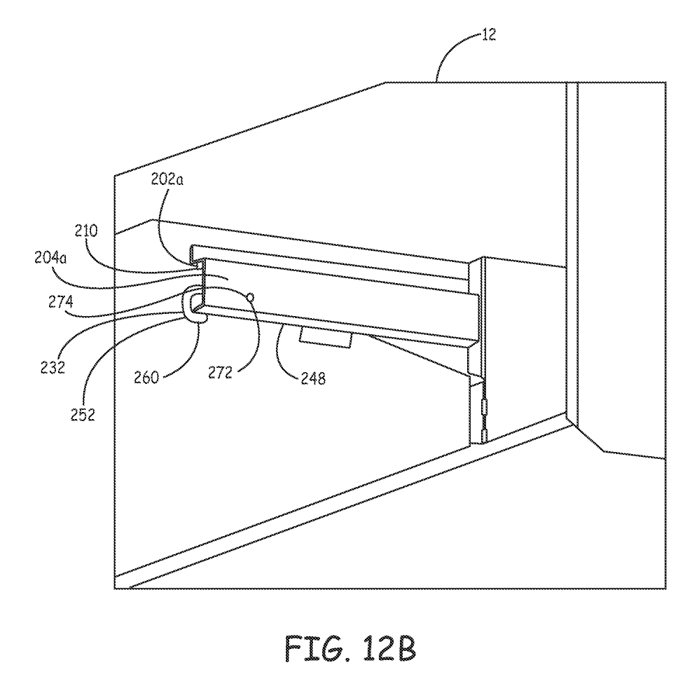

The spring arm 254 of the spring clip 232 includes a first end 264, a second end 266 and a middle portion 268. The second end 266 of the spring arm 254 is attached to the first end 256 of the lever arm 252 at an angle such that the lever arm 252 and the spring arm 254 form a shape substantially similar to a V-shape. The middle portion 268 of the spring arm 254 is curved and allows the first end 264 of the spring arm 254 to be compressed without overbending the spring clip 232. The spring clip 232 includes a rivet hole 270 between the lever arm 252 and the spring arm 254 and allows the spring clip 232 to be rotatably attached to a rivet hole 272 in the guide flange 244 of the first case bracket 204a by a rivet 274 (FIG. 12A).

FIG. 12B shows an enlarged perspective view of the spring clip 232 positioned within the first mounting bracket 204a in a compressed state. When the spring clip 232 is in the compressed state, the lever arm 252 and the spring arm 254 are pushed towards each other such that the spring clip 232 can be positioned between the top flange 222 and the bottom flange 224 of the casing 210. Referring also to FIGS. 9, 10 and 11, the spring clip 232 is positioned within the casing 210 such that the hook portion 260 of the lever arm 252 engages the bottom flange 224 of the first mounting bracket 202a at the leading end 220 of the guide flange 216 and the bottom flange 248 of the first case bracket 204a at the leading end 240 of the guide flange 244. In this position, the first end 264 of the spring arm 254 extends through the top cut-out 230 of the top flange 222 of the casing 210 and the cut-out 250 of the first case bracket 204a, allowing adjustment of the first case bracket 204a relative to the first mounting bracket 202a.

FIG. 12A shows an enlarged perspective view of the spring clip 232 positioned within the first mounting bracket 204a in a relaxed state. The rivet hole 270 of the spring arm 254 allows the spring clip 232 to rotate within the first case bracket 204a between the compressed state and the relaxed state. In the relaxed state, the lever arm 252 and the spring arm 254 are spaced from each another at a distance substantially equal to the distance between the top flange 222 and the bottom flange 224 of the casing 210. In the relaxed position, the protrusion 262 of the lever arm 252 is positioned to interface with the bottom cut-out 236 of the bottom flange 224 of the casing 210 to prevent movement and rotation. The first end 264 of the spring arm 254 also extends through the cut-out 230 of the top flange 222 of the casing 210 and contacts the top flange 246 of the first case bracket 204a, locking the first case bracket 204a to the first mounting bracket 202a.

To release the spring clip 232, the spring clip 232 is moved to the compressed state. The spring clip 232 is disengaged by pressing up on the lever arm 252 of the spring clip 232. The shape of the lever arm 252 and its relationship to the casing 210 and the first case bracket 204a prevents the spring clip 232 from overbending and breaking. As the lever arm 252 is pushed up, the first end 264 of the spring arm 254 slides along the top flange 246 of the first case bracket 204a until it extends through the cut-out 250 of the top flange 246 of the first case bracket 204a. Once the spring arm 254 extends through the cut-out 250, the hook portion 260 can be removed from the bottom flanges 224 and 248 of the first mounting bracket 202a and the first case bracket 204a, respectively. After the hook portion 260 of the lever arm 252 is disengaged from bottom flanges 224 and 248, the spring arm 254 is removed from the top cut-outs 230, 250 of the casing 210 and the first case bracket 204a, respectively. The first case bracket 204a is then free to slide off the first mounting bracket 202a.

Various modifications and additions can be made to the exemplary embodiments discussed without departing from the scope of the present invention. For example, while the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

The following is claimed:

1. A bracket assembly comprising:
a case bracket having an elongated channel;
a generally L-shaped mounting bracket having a first portion and a second portion, wherein the first portion has a protrusion for attaching the L-shaped mounting bracket to a vertical standard and wherein the second portion is slidable within the elongated channel; and
means for locking the case bracket to the L-shaped mounting bracket;
wherein the case bracket is slidable between an unlocked position and a locked position relative to the L-shaped mounting bracket.

2. The bracket assembly of claim 1, wherein the means for locking comprises one of a ball latch and a spring clip.

3. The bracket assembly of claim 1, wherein each of the elongated channel and the second portion of the L-shaped mounting bracket includes a cut-out, and wherein the cut-out of the elongated channel and the cut-out of the second portion of the L-shaped mounting bracket are aligned when the case bracket is in the locked position.

4. The bracket assembly of claim 3, wherein the means for locking engages the cut-out of the elongated channel and the cut-out of the second portion of the L-shaped mounting bracket when the case bracket is in the locked position.

5. The bracket assembly of claim 3, wherein the means for locking comprises a spring clip having a first end and a second end, wherein the first end of the spring clip is positioned through the cut-out of the elongated channel and the cut-out of the second portion of the L-shaped mounting bracket, and wherein the second end of the spring clip is positioned around edges of the elongated channel and the second portion of the L-shaped mounting bracket when the case bracket is in the locked position.

6. The bracket assembly of claim 1, wherein an end of the elongated channel is sloped.

7. The bracket assembly of claim 1, wherein the second portion of the mounting bracket comprises a C-shaped channel.

8. A locking bracket assembly comprising:
a case bracket including an elongated panel having a top extension extending substantially perpendicular to the elongated panel, a bottom extension extending substantially perpendicular to the elongated panel, and a cut-out;
a cantilever bracket slidable within the case bracket, the cantilever bracket comprising:
a mount flange having a protrusion for engaging an aperture of a vertical support; and
an elongated channel having a cut-out; and
a locking mechanism for locking the case bracket to the cantilever bracket, wherein the locking mechanism is positionable in a first position and a second position.

9. The locking bracket of claim 8, wherein the case bracket is slidable relative to the cantilever bracket when the locking mechanism is in the first position and wherein the case bracket is locked relative to the cantilever bracket when the locking mechanism is in the second position.

10. The locking bracket of claim 8, wherein when the locking mechanism is in the second position, the cut-out of the case bracket and the cut-out of the cantilever bracket are aligned and the locking mechanism is at least partially positioned within the cut-out of the case bracket and the cut-out of the cantilever bracket.

11. The locking bracket of claim 8, wherein the locking mechanism is one of a ball latch and a spring clip.

12. The locking bracket of claim 8, wherein a first end of the locking mechanism is positioned through the cut-outs of the case bracket and the cantilever bracket and wherein a second end of the locking mechanism is positioned around edges of the case bracket and the cantilever bracket when the locking mechanism is in the second position.

13. The locking bracket of claim 8, wherein an end of the elongated channel of the case bracket is sloped.

14. A method of locking a storage unit onto a vertical support, the method comprising:
attaching a mounting bracket to the vertical support, wherein the mounting bracket includes a channel having a cut-out;
attaching a case bracket onto the storage unit, wherein the case bracket includes a channel having a cut-out;
sliding the channel of the case bracket over the channel of the mounting bracket;
aligning the cut-out in the channel of the case bracket with the cut-out in the channel of the mounting bracket; and
engaging a locking mechanism through the cut-outs in the channels of the case bracket and the mounting bracket.

15. The method of claim 14, wherein engaging the locking mechanism comprises positioning a ball of a ball socket through the cut-outs in the channels of the case bracket and the mounting bracket.

16. The method of claim 14, wherein engaging the locking mechanism comprises positioning a protrusion at a first end of a spring clip through the cut-outs in the channels of the case bracket and the mounting bracket.

17. The method of claim 14, further comprising aligning an edge of the channel of the case bracket with an edge of the channel of the mounting flange.

18. The method of claim 17, wherein engaging the locking mechanism comprises:
positioning a first end of a spring clip through the cut-outs in the channels of the case bracket and the mounting bracket; and
positioning a second end of the spring clip around the edges of the channels of the case bracket and the mounting bracket.

19. The method of claim 14, wherein attaching the mounting bracket to the vertical support comprises positioning a protrusion of the mounting bracket within an aperture of the vertical support.

20. The method of claim 14, further comprising compressing the locking mechanism prior to engaging the locking mechanism.
